(19) United States
(12) Patent Application Publication
(10) Pub. No.: US 2022/0121282 A1
(43) Pub. Date: Apr. 21, 2022

(54) FINGER OPERATION DEVICE

(71) Applicant: Po-Hsun FAN, New Taipei City (TW)

(72) Inventor: Po-Hsun FAN, New Taipei City (TW)

(21) Appl. No.: 17/075,718

(22) Filed: Oct. 21, 2020

(51) Int. Cl. G06F 3/01; A41D 19/00

(52) U.S. Cl. CPC G06F 3/014; A41D 19/0024

(57) ABSTRACT

A finger operation device includes a glove and finger sleeves. The glove is formed with elongate grooves in an outside surface thereof to correspond to the finger openings. Each elongate groove is provided therein with sensors connected through a signal transmission line to a connection piece. Each finger sleeve receives one finger to extend therethrough. Each finger sleeve is axially extended to form a detection bar. The glove and the finger sleeves are put on a palm and the fingers. The detection bars are movable through swinging with a motion of the fingers so as to move in and out of the elongate grooves and positionable at different angles. The sensors detect the detection bars to generate signals that are transmitted through the signal transmission lines to a Bluetooth device connected with the connection piece to control operation of an electronic product paired with the Bluetooth device.

### TECHNICAL FIELD OF THE INVENTION

The present invention relates to a structure of a finger operation device, and more particularly to a device that detects motions of fingers and counts thereof for conversion into a Bluetooth signal to control an electronic device.

### DESCRIPTION OF THE PRIOR ART

Bluetooth is a technology standard for wireless transmission using shortwave ultra-high frequency radio waves for data exchange between fixed and mobile devices over short distances and building personal area networks and fins applications in telecommunications, computers, networks, and consumer electronic products, such as smart phones, tablet computers, virtual reality (VR) helmets, earphones, GOOGLE spectacles, and multimedia players. A user makes Bluetooth pairing to realize sharing of data contained in mobile devices and systems of electronic devices.

Examples include reading address books built in mobile phones and direct voice dialing by using voice recognition of a CUE system, and also reading music files contained in mobile phones or multimedia players for playing back with an automobile audio device by using the CUE system and showing the titles and lyrics of songs and also cover images of albums.

Further, Bluetooth may provide wireless connection among various electronic devices, such as connection among computers and peripheral devices, such as printers and keyboards, and may also enable communication of personal digital assistants (PDAs) with PDAs or computers in a neighboring area. Mobile phones equipped with Bluetooth technology may be connectable with computers, PDAs, or even hand-free earphones.

Although Bluetooth technology has been widely used, heretofore, practical operations still require finger pushing buttons or contacting touchscreens to accomplish desired functions. This is quite inconvenient.

VR devices that are recently prevailing or electronic game machines, in performing inter-device data transmission, require users to carry out such operations by hand holding associated handheld devices.

### SUMMARY OF THE INVENTION

An objective of the present invention is to provide a finger operation device that detects motions of fingers and counts thereof for conversion into a Bluetooth signal to control an electronic product.

The present invention provides a finger operation device, comprising: a glove, which comprises a base part and five finger openings formed in the base part, the finger openings being provided to receive five fingers of a hand to extend therethrough, wherein portions of an outside surface of the glove corresponding to the finger openings are each formed with an elongate groove extended in an axial direction of a corresponding one of the finger openings; each of the elongate grooves is provided with a plurality of sensors arranged in an interior of the elongate groove and the sensors provided in each of the elongate grooves are connected to a signal transmission line, the signal transmission line being embedded in an interior of the glove; and the base part is connected to a connection piece in connection with a Bluetooth device and the connection piece and the signal transmission line are electrically connected with each other; and a plurality of finger sleeves, which are each arranged to receive one of the fingers to extend therethrough, each of finger sleeves being provided with a detection bar that is extended axially and is receivable in a corresponding one of the elongate grooves; wherein in a condition that the glove is put on a user palm and the finger sleeves are put on the fingers, the detection bars are movable through swinging with a motion of the fingers so as to be movable in and out of the elongate grooves as being positionable at various angles, and the sensors provided in the elongate grooves detect the detection bars and generate signals, wherein the signals are transmitted through the signal transmission lines to the Bluetooth device in connection with the connection piece and adapted to control operation of an electronic product paired with the Bluetooth device.

Preferably, the sensors provided in each of the elongate grooves are arranged in a pairwise form and are arranged on a circuit board at two opposite sides of the circuit board to form two linear arrays, wherein the circuit board is disposed in the elongate groove and the two linear arrays of the sensors are located in the elongate groove and at two opposite sides of the elongate groove, so that the detection bar is receivable between the sensors provided on the two opposite sides.

Preferably, the detection bar comprises a metal bar.

Preferably, lengths of the finger openings are respectively corresponding to lengths of first finger segments of the five fingers, so as avoid interference with motions of the fingers on which the finger sleeves are put.

The finger operation device provided in the present invention allows a user to control the operation or function of a paired electronic device by using motions of fingers, achieving unitization of man and machine.

### BRIEF DESCRIPTION OF THE DRAWINGS

FIG. 1 is a schematic view showing a structure of a glove and finger sleeves and a connection relationship thereof according to the present invention.

FIG. 2 is a schematic view showing the glove and the finger sleeves according to the present invention put on a hand of a user and connected with each other.

FIG. 3 is a cross-sectional view showing the glove and the finger sleeves according to the present invention put on a hand of a user in a condition that the fingers are in a straight state with a detection bar located in an elongate groove of the glove.

FIG. 4 is a cross-sectional view showing the glove and the finger sleeves according to the present invention put on the hand of the user in a condition that the fingers are slightly curving and the detection bar slightly and partly swings off the elongate groove of the glove.

FIG. 5 is a cross-sectional view illustrating a condition when a finger of a user is further curving, making the detection bar further and more significantly swinging off the elongate groove of the glove.

### DETAILED DESCRIPTION OF THE PREFERRED EMBODIMENT

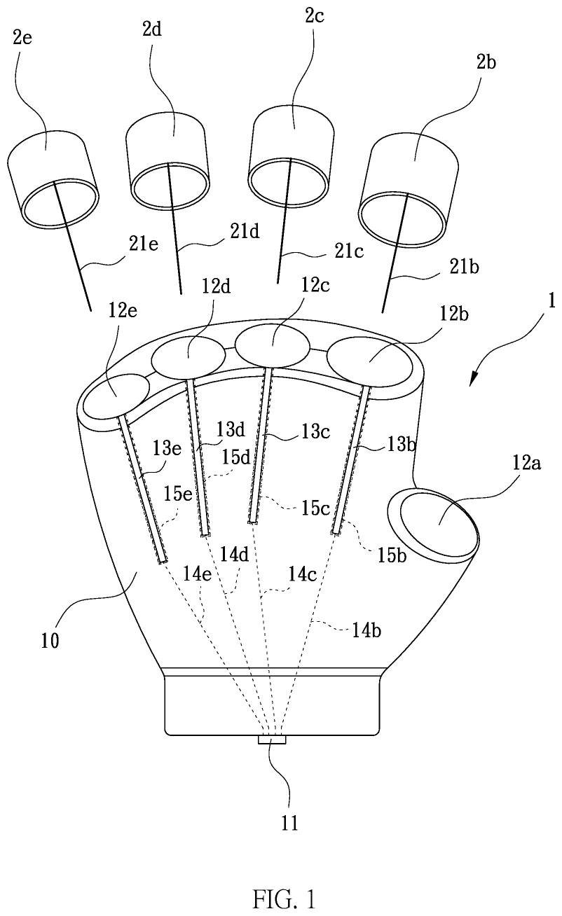

As shown in FIG. 1, the present invention provides a finger operation device, of which a preferred embodiment comprises a glove 1 and a plurality of finger sleeves 2. The glove 1 includes a base part 10 and five finger openings 12a-12e formed in the base part 10. The finger openings 12a-12e are provided to respectively receive five fingers to extend therethrough. For example, the thumb extends through the finger opening 12a; the index finger extends through the finger opening 12b; the middle finger extends through the finger opening 12c; the ring finger extends through the finger opening 12d; and the little finger extends through the finger opening 12e. Specifically, the glove 1 can be made of any proper material (such fabric) to have a configuration similar to a hand glove but only including the base part 10 that covers a the dorsal part of a hand, which is the part of the hand that is opposite to the palm, and not covering the palm of the hand. In other words, the base part 10 is a sheet of material that corresponds to the hand back only. The finger openings 12a-12e are arranged, in a distributed manner, in a front end of the base part 10 and have different lengths to respectively correspond to the lengths of the first finger segments of the five fingers of a person.

For example, the finger opening 12a has a length corresponding to the length of the first finger segment of the thumb, so that the first finger segment of the thumb is covered by the finger opening 12a after the thumb extends through the finger opening 12a. The finger opening 12b has a length corresponding to the length of the first finger segment of the index finger, so that the first finger segment of the index finger is covered by the finger opening 12b after the index finger extends through the finger opening 12b. The finger opening 12c has a length corresponding to the length of the first finger segment of the middle finger, so that the first finger segment of the middle finger is covered by the finger opening 12c after the middle finger extends through the finger opening 12c. The finger opening 12d has a length corresponding to the length of the first finger segment of the ring finger, so that the first finger segment of the ring finger is covered by the finger opening 12d after the ring finger extends through the finger opening 12d. The finger opening 12e has a length corresponding to the length of the first finger segment of the little finger, so that the first finger segment of the little finger is covered by the finger opening 12e after the little finger extends through the finger opening 12d.

The term first finger segment used herein refers to a distance from a root (or approximately the metacarpophalangeal joint or knuckle) of a finger to the first interphalangeal joint of the finger. Thus, when the fingers are respectively put through the finger openings 12a-12e, the second finger segment and the third finger segment of each of the fingers are exposed outside the corresponding finger opening 12a-12e.

The glove 1 has an outside surface that is formed, at locations respectively corresponding to the finger openings 12b-12e, with elongate grooves 13b-13e that are respectively extended in axial directions of the finger openings 12b-12e. Each of the elongate grooves 13b-13e is provided, in an interior thereof, with a plurality of sensors 15b-15e, and the sensors 15b-15e are respectively connected with signal transmission lines 14b-14e. The signal transmission lines 14b-14e are embedded in an interior of the glove 1. Further, the base part 10 of the glove 1 is connected with a connection piece 11 of a Bluetooth device (not shown). The connection piece 11 is electrically connected with the signal transmission lines 14b-14e, in order to provide connection for signal communication between the Bluetooth device and the sensors 15b-15e.

More specifically, the sensors 15b-15e provided in each of the elongate grooves 13b-13e are arranged in a pairwise manner on a circuit board (not shown), as being respectively set at two opposite sides of the circuit board to form two straight lines (as shown in FIG. 1). The circuit board is mounted in the elongate groove 13b-13e, and the two straight linear arrangements of the sensors 15b-15e are located on two opposite sides in the elongate groove 13b-13e. Preferably, the pairwise arrangement of the sensors 15b-15e includes an infrared transmitter and an infrared receiver, wherein the infrared transmitter emits an infrared ray, which is receivable by the infrared receiver corresponding thereto to generate a signal, or oppositely, no signal is generated.

The present invention provides four finger sleeves 2b-2e for respectively receiving the index finger, the middle finger, the ring finger and the little finger to extend therethrough. Each of the finger sleeves 2b-2e has an end portion from which a detection bar 21b-21e of a predetermined length extends axially. The detection bars 21b-21e are respectively receivable into the elongate grooves 13b-13e as being positionable between the two arrays of the sensors 15b-15e of each groove.

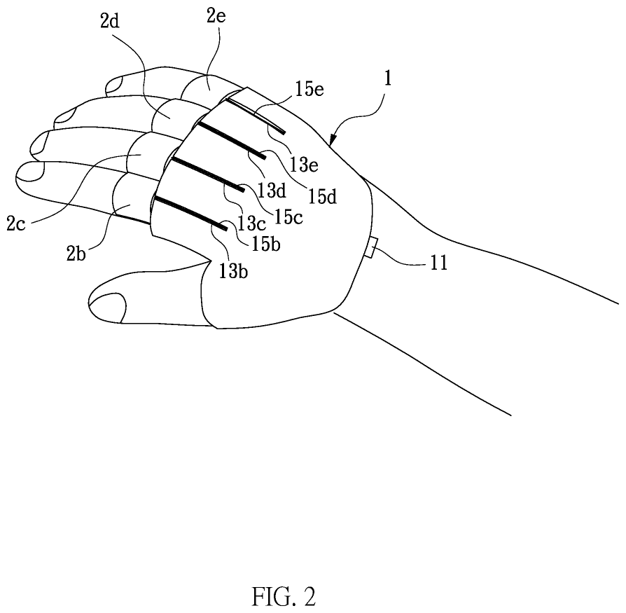

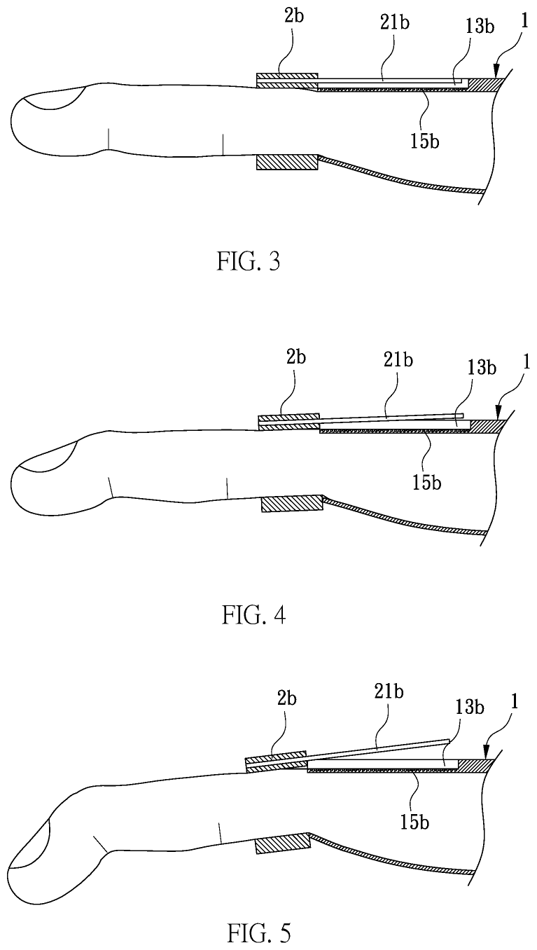

Operation of the present invention is that the Bluetooth device is first connected, through transmission lines, to the connection piece 11, and then, the glove 1 is put on the back of a user's hand and the finger sleeves 2 are put on the user's fingers (as shown in FIG. 2). Under such a condition, the detection bars 21b-21e are movable, such as swinging, with a motion of the user's fingers (as shown in FIGS. 3-5), so that the detection bars 21b-21e may be moved in and out of the elongate grooves 13b-13e as being positioned at different angles, wherein the sensors 15b-15e that are arranged inside the elongate grooves 13b-13e detect swing angles of the detection bars 21b-21e and generate signals corresponding to the detection. The signals so generated transmit through the signal transmission lines 14b-14e to the Bluetooth device that is connected to the connection piece 11 to control the operation of an electronic product that is paired with the Bluetooth device.

FIGS. 3-5 provide an example for demonstration with the glove 1 put on a hand and the finger sleeve 2b put on the index finger. However, this is equally applicable to arrangements that the finger sleeves 2c-2e are put on the middle finger, the ring finger, and the little finger. For example, as shown in FIG. 3, when the finger is set in a straight state, the detection bar 21b is drawn by the finger sleeve 21b to be completely received and located inside the elongate groove 13b, such that the entire length of the detection bar 21b can be detected by all of the sensors 15b. Thus, a microcomputer may compute and determine that the finger is set in a straight state and a signal corresponding thereto is generated. The signal is transmitted through the signal transmission line 14b to the Bluetooth device that is connected to the connection piece 11 to control the operation of an electronic product paired with the Bluetooth device.

As shown in FIG. 4, when the finger is slightly or partly curved, the detection bar 21b is drawn by the finger sleeve 21b to slightly or partly swing out of the elongate groove 13b. Under this condition, a portion of the sensors 15b does not detect the detection bar 21b, and only a portion of the length of the detection bar 21b is detected. Thus, the microcomputer, upon performance of computation, determines that the finger is set in a slightly curving state and a signal corresponding thereto is generated. The signal is transmitted through the signal transmission line 14b to the Bluetooth device that is connected to the connection piece 11 to control the operation of an electronic product paired with the Bluetooth device.

As shown in FIG. 5, when the finger is further curved to a greater extent, the detection bar 21b is drawn by the finger sleeves 21b to more greatly swing out of the elongate groove 13b. Under this condition, more of the sensors 15b do not detect the detection bar 21b, and only an even reduced portion of the length of the detection bar 21b is detected. Thus, the microcomputer, upon performance of computation, determines that the finger is set in a significantly curving state and a signal corresponding thereto is generated. The signal is transmitted through the signal transmission line 14b to the Bluetooth device that is connected to the connection piece 11 to control the operation of an electronic product paired with the Bluetooth device.

Thus, the present invention provides a finger operation device, which allows a user to control the operation or function of a paired electronic device by using motions of fingers, achieving unitization of man and machine.

1. A finger operation device, comprising:
a glove, which comprises a base part and five finger openings formed in the base part, the finger openings being adapted to receive five fingers of a hand to extend therethrough, wherein portions of an outside surface of the glove corresponding to the finger openings are each formed with an elongate groove extended in an axial direction of a corresponding one of the finger openings; each of the elongate grooves is provided with a plurality of sensors arranged in an interior of the elongate groove and the sensors provided in each of the elongate grooves are connected to a signal transmission line, the signal transmission line being embedded in an interior of the glove; and the base part is connected to a connection piece in connection with a Bluetooth device and the connection piece and the signal transmission line are electrically connected with each other; and
a plurality of finger sleeves, which are each adapted to receive one of the fingers to extend therethrough, each of finger sleeves being provided with a detection bar that is extended axially and is receivable in a corresponding one of the elongate grooves;
wherein in a condition that the glove is put on a user palm and the finger sleeves are put on the fingers, the detection bars are movable through swinging with a motion of the fingers so as to be movable in and out of the elongate grooves as being positionable at various angles, and the sensors provided in the elongate grooves detect the detection bars and generate signals, wherein the signals are transmitted through the signal transmission lines to the Bluetooth device in connection with the connection piece and adapted to control operation of an electronic product paired with the Bluetooth device;
wherein each of the elongate grooves is formed as being recessed from a surface of the base part and has an elongate opening coplanar with the surface of the base part and coextensive with the elongate groove, and wherein the detection bar that is receivable in the elongate groove is movable to have a distal end of the detection bar selectively moving out of the elongate groove through the elongate opening in a direction away from the surface of the base part.

2. The finger operation device according to claim 1, wherein the sensors provided in each of the elongate grooves are arranged in a pairwise form and are arranged on a circuit board at two opposite sides of the circuit board to form two linear arrays, wherein the circuit board is disposed in the elongate groove and the two linear arrays of the sensors are located in the elongate groove and at two opposite sides of the elongate groove.

3. The finger operation device according to claim 1, wherein the detection bar comprises a metal bar.

4. The finger operation device according to claim 1, wherein lengths of the finger openings are respectively corresponding to lengths of first finger segments of the five fingers.
